(19) United States
(12) Patent Application Publication
(10) Pub. No.: US 2022/0308756 A1
(43) Pub. Date: Sep. 29, 2022

(54) Performing Memory Accesses for Input-Output Devices using Encryption Keys Associated with Owners of Pages of Memory

(71) Applicant: ATI Technologies ULC, Markham (CA)

(72) Inventors: Nippon Raval, Mississauga (CA); Philip Ng, Toronto (CA)

(21) Appl. No.: 17/214,686

(22) Filed: Mar. 26, 2021

(51) Int. Cl. G06F 3/06

(52) U.S. Cl. CPC G06F 3/061; G06F 3/0622; G06F 3/0655; G06F 3/0679

(57) ABSTRACT

An electronic device includes an input-output memory management unit (IOMMU). The IOMMU receives, from an input-output device, a memory access request directed to a given page of memory. The IOMMU then determines a particular encryption key from among a plurality of encryption keys associated with an owning entity to which the given page of memory is assigned. The IOMMU next communicates, to a encryption functional block, a specification of the particular encryption key to be used for encryption-related operations for processing the memory access request.

### BACKGROUND

### Related Art

Some electronic devices include a processor (e.g., a central processing unit, etc.) and a memory in which data is stored. Many electronic devices also include input-output (IO) devices such as network interface devices, disk controllers, etc. The IO devices often interact with the processor and memory for performing various operations. For example, a network interface device may store data received via a network in the memory and then signal the processor that the data stored in the memory is awaiting processing.

Some electronic devices support “virtualization” of electronic device hardware such as input-output (IO) devices, memory, etc. Virtualization involves an intermediary entity in or executed by the electronic device providing, to software entities executing on the electronic device (e.g., application programs, etc.), the illusion that the software entities are accessing electronic device hardware directly, when, in reality, the intermediary entity intercepts/redirects or otherwise assists with accesses made by the software entities. One common intermediary entity is a virtual machine. Virtual machines are software entities that abstract electronic device hardware and emulate or present a known interface to the electronic device hardware, thereby enabling other software entities to execute on, and possibly share, various types and arrangements of underlying electronic device hardware—possibly including electronic device hardware with which the other software entities would otherwise not be compatible. In some electronic devices, virtual machines provide support for executing one or more instances of operating systems, called “guest” operating systems. Guest operating systems in turn provide environments for executing software entities such as productivity applications, databases, etc. In some electronic devices, the virtual machines themselves are managed and controlled by a software entity known as a hypervisor (or virtual machine manager). Hypervisors can start or initialize virtual machines; control, monitor, and assist with accesses of electronic device hardware by virtual machines; terminate or close virtual machines; etc. In some electronic devices, hypervisors also assist with interactions between input-output (IO) devices and electronic device hardware.

In some electronic devices, a portion of the memory is assigned to a particular software entity (e.g., a hypervisor, a guest operating system, etc.) and thereby reserved for that software entity's use. For example, a guest operating system may be assigned a number of pages of memory that are reserved for storing data for the guest operating system (where “pages” of memory are blocks of memory of a specified size, such as 4 KiB, 2 MiB, etc.). In some cases, pages of memory (or other assigned portions of memory) that are assigned to a software entity are secured against undesired accesses by encrypting data in the pages of memory with an encryption key that is assigned to that software entity. For example, pages of memory assigned to a hypervisor may be encrypted using an encryption key assigned to the hypervisor.

In some electronic devices, the memory in an electronic device is partitioned into a number of regions. For example, groups of addressable locations in the memory can be considered part of respective regions (e.g., a W GiB memory can have Y MiB regions). As another example, the memory can be implemented using two or more types of memory circuitry (e.g., volatile memory circuitry and/or non-volatile memory circuitry) and the memory can be partitioned into regions based on the types of memory circuitry. In these electronic devices, software entities can be assigned pages of memory (or other portions of memory) in two or more different regions of memory. For example, a guest operating system may be allocated pages of memory in a volatile memory and in a non-volatile memory. When a software entity is assigned pages of memory in two or more regions of memory and the pages of memory are to be encrypted, the pages of memory in each region can be encrypted using a different encryption key. For instance, pages of memory assigned to a software entity in a first region of memory are encrypted using a first encryption key, pages of memory assigned to the software entity in a second region of memory are encrypted using a second encryption key, etc. In some cases, each software entity is associated with a different encryption key for each region of memory, so an electronic device executing P software entities with X regions of memory can use P*X encryption keys.

In some electronic devices, IO devices access data in pages of memory that are assigned to software entities, such as for storing data in the pages of memory for use by the software entities. At least some of these IO devices do not provide support for accessing encrypted data, e.g., lack hardware and/or software for accessing encrypted data on their own. These IO devices therefore need assistance from an intermediary entity for accessing encrypted data in pages of memory assigned to software entities. For example, an input-output memory management unit (IOMMU) may intercept memory accesses by IO devices and handle operations relating to encryption and/or decryption of accessed data in memory. In existing IOMMUs, however, there is no mechanism for simply and efficiently handling IO device accesses of encrypted data in multiple regions of memory using different encryption keys. Such accesses are therefore performed via the hypervisor and/or other entities and can be slow and inefficient (i.e., cause load on the processor, consumption of memory system bandwidth, etc.).

### BRIEF DESCRIPTION OF THE FIGURES

FIG. 1 presents a block diagram illustrating an electronic device in accordance with some embodiments.

FIG. 2 presents a block diagram illustrating regions in a memory in accordance with some embodiments.

FIG. 3 presents a block diagram illustrating an operating system and electronic device hardware in an electronic device in accordance with some embodiments.

FIG. 4 presents a block diagram illustrating a hypervisor and electronic device hardware in an electronic device in accordance with some embodiments.

FIG. 5 presents a flowchart illustrating a process for handling memory accesses for IO devices in encrypted pages of memory in regions in a memory in accordance with some embodiments.

FIG. 6 presents a block diagram illustrating a page table in accordance with some embodiments.

FIG. 7 presents a block diagram illustrating overloading an encryption key identifier in address information in a page table entry in accordance with some embodiments.

FIG. 8 presents a block diagram illustrating an encryption key identifier in metadata in a page table entry in accordance with some embodiments.

FIG. 9 presents a flowchart illustrating a process for determining an encryption key from among a set of encryption keys using information from a page table entry in accordance with some embodiments.

FIG. 10 presents a block diagram illustrating a reverse map table in accordance with some embodiments.

FIG. 11 presents a flowchart illustrating a process for determining an encryption key from among a set of encryption keys using information from a reverse map table entry in accordance with some embodiments.

Throughout the figures and the description, like reference numerals refer to the same figure elements.

### DETAILED DESCRIPTION

The following description is presented to enable any person skilled in the art to make and use the described embodiments and is provided in the context of a particular application and its requirements. Various modifications to the described embodiments will be readily apparent to those skilled in the art, and the general principles described herein may be applied to other embodiments and applications. Thus, the described embodiments are not limited to the embodiments shown, but are to be accorded the widest scope consistent with the principles and features described herein.

### Terminology

In the following description, various terms are used for describing embodiments. The following is a simplified and general description of some of the terms. Note that these terms term may have significant additional aspects that are not recited herein for clarity and brevity and thus the description is not intended to limit these terms.

Functional block: functional block refers to a set of interrelated circuitry such as integrated circuit circuitry, discrete circuitry, etc. The circuitry is “interrelated” in that circuit elements in the circuitry share at least one property. For example, the circuitry may be included in, fabricated on, or otherwise coupled to a particular integrated circuit chip, substrate, circuit board, or portion thereof, may be involved in the performance of specified operations (e.g., computational operations, control operations, memory operations, etc.), may be controlled by a common control element and/or a common clock, etc. The circuitry in a functional block can have any number of circuit elements, from a single circuit element (e.g., a single integrated circuit logic gate or discrete circuit element) to millions or billions of circuit elements (e.g., an integrated circuit memory). In some embodiments, functional blocks perform operations “in hardware,” using circuitry that performs the operations without executing program code.

Data: data is a generic term that indicates information that can be stored in memories and/or used in computational, control, and/or other operations. Data includes information such as actual data (e.g., results of computational or control operations, outputs of processing circuitry, inputs for computational or control operations, variable values, sensor values, etc.), files, program code instructions, control values, and/or other information Data can be organized into logical blocks (e.g., a 4 KiB or 2 MiB page of memory, etc.) that include one or more of the above-described types of information for operations such as loading the data into a memory, migration of data in a memory, etc.

Accesses: accesses, as applied to interactions with data stored in memories (e.g., main memories, cache memories, etc.), or “memory accesses,” indicates all forms of interactions that can be performed for, on, using, and/or with data and corresponding metadata and/or control values. For example, accesses can include reads or loads of data from memories, writes or stores of data to memories, invalidations, deletions, or moves of data in memories, reads or writes of metadata for data in memories, changes of status, coherency state, or permissions for data in memories, etc. When a particular type of memory access is allowed/permitted for a given functional block or device, the data is “accessible” to the given functional block or device.

### Virtual Memory

In the described embodiments, an electronic device uses a virtual memory technique for handling data accesses by software entities being executed in the electronic device (e.g., application programs, operating systems, device drivers, virtual machines, etc.) or by input-output (IO) devices (e.g., network interface devices, Peripheral Component Interface Express (PCIe) bus devices, disk controllers, etc.). Generally, when data is initially accessed by a software entity or an IO device, a block or page of memory of a given size (e.g., 4 KiB, 2 MiB, etc.) that includes the data is copied from mass storage (e.g., a disk drive or a non-volatile semiconductor memory) to an available physical location in a memory (e.g., a main memory) in the electronic device—or a page of memory is newly created in the memory (e.g., for storing the results of computational or other operations, etc.). In order to avoid software entities and IO devices being required to keep track of the physical locations of pages in memory, the electronic device keeps track of the physical locations of the pages for the software entities or IO devices. The software entities and IO devices access memory using “virtual” addresses in virtual address spaces, which are local address spaces that are specific to corresponding software entities and/or IO devices, instead of accessing memory using addresses based on the physical locations (or physical addresses) of data in the memory. From a software entity's or an IO device's perspective, virtual addresses indicate the actual physical locations where data is stored in memory, and memory accesses are made by software entities and IO devices using the virtual addresses accordingly. The virtual addresses, however, may not map directly to the physical addresses of the physical locations where data is stored in pages in the memory. As part of keeping track the physical locations of pages, the electronic device translates the virtual addresses used by the software entities and IO devices in memory access requests into the physical addresses where the data is actually located. The electronic device then uses the physical addresses to perform the memory accesses for the software entities and IO devices.

In order to enable the above-described virtual address to physical address translations, the electronic device includes a page table. The page table is a record stored in a memory of the electronic device that includes an entry, or a “page table entry,” with virtual address to physical address translation information and other information for pages of data that are stored in the memory. In other words, the page table includes mappings of virtual addresses to corresponding physical addresses for each page of data that is present in the memory. Upon receiving a request from a software entity or an IO device to access memory at a given virtual address, the electronic device acquires corresponding physical address information from the page table by performing a page table walk, during which the page table is searched for a page table entry that provides the physical address associated with the virtual address. For example, upon receiving a request from an operating system to access memory at a given virtual address, a memory management unit (MMU) in a central processing unit (CPU) core in the electronic device can perform a page table walk to acquire corresponding physical address information from the page table and can process the memory access using the physical address information. As another example, upon receiving a request from an IO device to access memory at a given virtual address, an input-output memory management unit (IOMMU) in the electronic device can perform a page table walk to acquire corresponding physical address information from the page table and can process the memory access using the physical address information.

Because the above-described page table walks are relatively slow, it is desirable to avoid performing page table walks. The electronic device therefore includes translation lookaside buffers (TLBs), which are local caches that are used for storing a limited number of copies of address translation information acquired during page table walks (i.e., information based on page table entries). For example, a CPU can include a TLB that is used for locally storing copies of information based on page table entries (or copies of the page table entries themselves) that is used for memory accesses for software entities. As another example, an IOMMU can include a TLB that is used for locally storing copies of information based on page table entries (or copies of the page table entries themselves) that is used for memory accesses for IO devices. During operation, the CPU core or IOMMU first attempts to acquire cached page table entries from the corresponding TLB for performing virtual address to physical address translations. When the copy of the corresponding page table entry is not present in the TLB (i.e., when a “miss” occurs), the CPU core or IOMMU performs a page table walk to acquire the desired page table entry. The CPU core or IOMMU can then cache a copy of the acquired page table entry in the respective TLB for subsequent use.

### Virtual Machines and Hypervisors

In some embodiments, a processor in an electronic device executes one or more virtual machines. Virtual machines are software entities that emulate or otherwise interface with the processor and other functional blocks and devices in the electronic device (e.g., memories, IO devices, etc.) in order to provide support for executing software programs. For example, a virtual machine may provide support for running one or more instances of operating systems, called guest operating systems. The guest operating systems in turn provide support for executing other software programs such as applications, databases, etc.

In some embodiments, the processor also executes a hypervisor. The hypervisor is a software entity that performs operations for controlling and managing the execution of virtual machines. For example, the hypervisor may start and initialize virtual machines, assist with controlling accesses of functional blocks and devices in the electronic device by virtual machines (e.g., dictate which regions of memory and/or IO devices the virtual machines are allowed to access, etc.), terminate or close virtual machines, etc. An arrangement of virtual machines and hypervisors as can be found in some embodiments is shown in FIG. 3.

### Page Tables

In the some embodiments, guest operating systems, IO devices, the IOMMU, and the hypervisor in an electronic device use the virtual memory technique for memory accesses. Programs executed under guest operating systems, the guest operating systems themselves, and IO devices can use local addresses for memory accesses. For example, programs executed under a guest operating system can access memory using guest virtual addresses and IO devices can access memory using guest physical addresses or guest virtual addresses. As described above, the local addresses in memory accesses from programs, guest operating systems, and IO devices are translated before data can be accessed in the memory. For example, guest virtual addresses in memory accesses from programs can be translated into guest physical addresses. The guest physical addresses, however, are themselves virtual—i.e., are the guest operating systems' view of the organization of data in the memory—and so the guest physical addresses are translated into system physical addresses where data is located in the memory. As another example, guest physical addresses in memory accesses from IO devices can be translated into system physical addresses where the data is located in the memory.

In some embodiments, in order to support the programs, guest operating systems, and IO devices using local addresses, the electronic device uses a set of page tables for address translations. The page tables include a guest page table for each guest operating system that is used for translating guest virtual addresses in memory accesses to guest physical addresses. The page tables also include a nested (i.e., host, system, etc.) page table that is used for translating guest physical addresses in memory accesses into system physical addresses. The page tables additionally include an IO page table that is used for translating guest physical addresses in memory accesses from IO devices into system physical addresses. Note, however, that, in some embodiments, the information in the IO page table is included in/combined with the information in the nested page table and the nested page table is used for all translations of guest physical addresses to system physical addresses.

As an example using the above-described page tables for translating addresses, in some embodiments, upon receiving a memory access request from a program that includes a guest virtual address via a guest operating system, a processor uses a respective guest page table and the nested page table in sequence for performing the translation. In other words, the processor (e.g., a guest operating system) first uses the guest page table associated with that guest operating system to translate the guest virtual address into a guest physical address. The processor (e.g., a hypervisor) then uses the nested page table to translate the guest physical address into a system physical address. Upon acquiring the system physical address, the processor uses the system physical address for performing the memory access. The processor may also cache the system physical address in a TLB in the processor.

As another example of the use of the above-described page tables for translating addresses, in some embodiments, upon receiving a memory access request from an IO device that includes a guest physical address, an IOMMU uses the IO page table for performing the translation. In other words, the IOMMU uses the IO page table to translate the guest physical address into a system physical address. Upon acquiring the system physical address, the IOMMU uses the system physical address for performing the memory access. Alternatively, in some embodiments, upon receiving a memory access request from an IO device that includes a guest virtual address, the IOMMU uses a respective guest page table and the IO page table in sequence for performing the translation. In other words, the IOMMU first uses the respective guest page table to translate the guest virtual address into a guest physical address. The IOMMU then uses the IO page table to translate the guest physical address into a system physical address. Upon acquiring the system physical address, the IOMMU uses the system physical address for performing the memory access. The IOMMU may also cache system physical addresses in a TLB in the IOMMU.

### Reverse Map Table

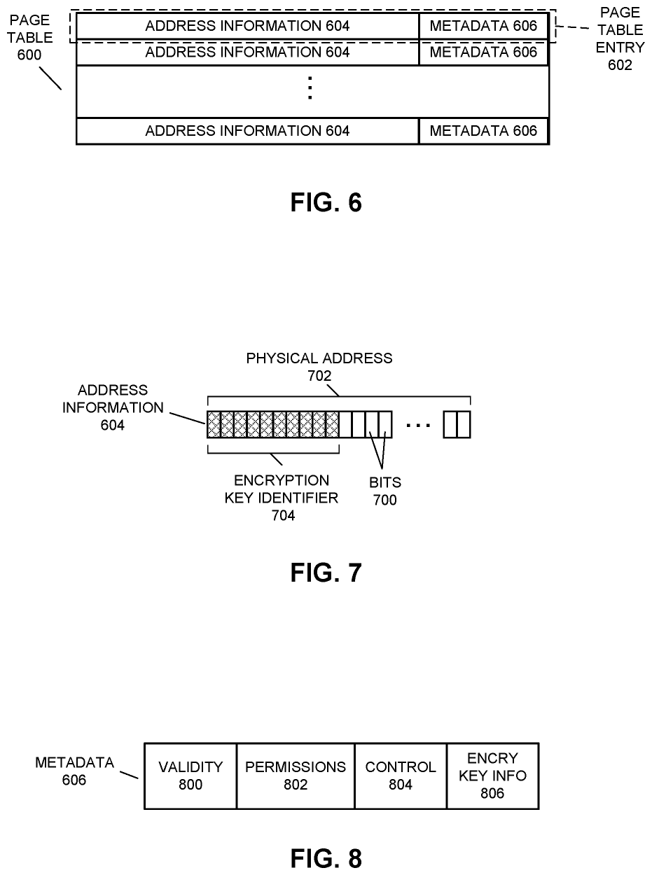

In the described embodiments, the hypervisor (and/or other software entities, functional blocks, and/or devices) can modify information in the nested page table. For example, hypervisor can change mappings from guest physical addresses to system physical addresses in the nested page table. Such changes are normal—and necessary when properties of pages of memory are modified, such when pages of memory are moved in the memory, the ownership of pages of memory is changed, etc. Because the hypervisor can change information in the nested page table, if the hypervisor were to maliciously or erroneously change information in page table entries, the electronic device could experience unintended or unexpected operation. The described embodiments therefore perform operations for ensuring that information in the nested page table has not been unexpectedly or impermissibly changed by the hypervisor. For these operations, the described embodiments use a reverse map table (RMT) to ensure that, among other things, the hypervisor (and/or another entity) has not remapped translations from guest physical addresses to system physical addresses in the nested page table. The reverse map table is a record in memory that includes information that can be used to determine, among other things, which entity owns a page of memory (e.g., a guest operating system to which the page of memory is assigned or the hypervisor), and whether a system physical address acquired during a table walk of the nested page table for a guest physical address is assigned to that guest physical address. In other words, the reverse map table can be used to ensure that a system physical address for a given page in memory is matched to only one guest physical address at a time, which prevents the erroneous or malicious remapping of such addresses. An example of a reverse map table is shown in FIG. 6.

### Overview

In the described embodiments, an electronic device includes a processor, a memory (e.g., a “main” memory), and a number of input-output (IO) devices (e.g., network interface devices, disk drives, etc.). The memory is divided into two or more regions, each region including a separate subset of memory circuitry in the memory. For example, groups of addressable locations in the memory can be considered part of respective regions so that the memory is partitioned into a number of regions. The processor executes software entities including a hypervisor and guest operating systems. Some or all of the software entities are assigned pages of memory that are reserved for storing data for the software entity to which they are assigned. The software entities can be assigned pages of memory in each of the two or more regions. For instance, in some embodiments, a guest operating system can be assigned pages of memory in a first region (e.g., a region in a first group of addressable locations) along with pages of memory in a second region (e.g., a region in a second group of addressable locations).

In the described embodiments, data in pages of memory assigned to software entities can be encrypted in order to protect the data. Generally, encrypting data involves using a key (i.e., an M-bit value, where M is 128, 256, etc.) as an input to an encryption functional block (e.g., in a memory controller) that encrypts data before storing the encrypted data in the pages of memory and decrypts data from the pages of memory for loading/reading the data. The data in pages of memory is encrypted using keys associated with a combination of the software entity to which the pages of memory are assigned and the region of memory in which the pages of memory are located. In other words, software entities can have a different key associated with each region in the memory that is used for performing encryption operations for assigned pages of memory in that region of memory. For example, in an embodiment where there are K regions of memory, a hypervisor can have K different encryption keys, each encryption key associated with a respective one of the of K regions of memory (where K=2, 5, or another number). When accessing data in a page of memory assigned to a given software entity, an accessing entity (e.g., the processor, an input-output memory management unit (IOMMU), etc.) uses the associated encryption key for encryption-related operations (e.g., encryption, decryption, etc.). For example, in some embodiments, along with a memory access request, an accessing entity communicates a specification of an encryption key to the encryption functional block be used for performing encryption-related operations for the memory access.

In some embodiments, the IOMMU handles accesses of encrypted data in pages of memory on behalf of the IO devices. Generally, for handling memory accesses of encrypted data in pages of memory, the IOMMU determines encryption keys that are to be used for memory accesses for IO devices and then provides specifications of the encryption keys (e.g., numerical identifiers for the encryption keys, etc.) to the encryption functional block for use by the encryption functional block in selecting keys for performing encryption operations for the memory accesses. For example, in some embodiments, the IOMMU receives, from an IO device, a memory access request for a page of memory that is assigned to a software entity, or an “owning entity,” in a region of the memory. The IOMMU then determines an encryption key to be used for performing the memory access from among the encryption keys associated with the owning entity. In other words, the IOMMU, based on the owning entity and the region of memory in which the page of memory is stored, determines a respective encryption key from among all of the encryption keys associated with the owning entity (and, more generally, from among all of encryption keys in use in the electronic device). The IOMMU next communicates a specification of the encryption key to the encryption functional block with the memory access request. The encryption functional block then uses the specification of the encryption key for retrieving an encryption key to be used for performing encryption and/or decryption operations for the memory access request. For example, the encryption functional block may use the specification to look up the encryption key in an encryption key table, retrieve the encryption key from an encryption key store, or otherwise acquire the encryption key.

In some embodiments, the IOMMU uses information from a page table for determining encryption keys from among encryption keys associated with owning entities for memory access requests from IO devices. In these embodiments, page table entries include identifiers for encryption keys with which data in corresponding pages of memory are encrypted. For example, in some embodiments, the identifiers for the encryption keys are stored in physical address information in the page table entries. In these embodiments, specified bits, such as a highest P bits (where P=8, 10, or another value), of physical addresses in page table entries are overloaded with the identifiers for the encryption keys. In other words, the physical address information that would typically be stored in these bits is replaced, or “overloaded,” with an identifier for an encryption key (and the physical address information is limited in addressable scope in comparison to embodiments in which the physical addresses are not overloaded). As another example, in some embodiments, the identifiers for the encryption keys are stored in dedicated encryption key identifier bits in the page table entries. For determining the encryption keys in these embodiments, the IOMMU acquires the identifiers from the page table entries during page table walks associated with memory accesses. Alternatively, the IOMMU can acquire the identifiers from cached copies of information from page table entries acquired during earlier page table walks (e.g., from a translation lookaside buffer (TLB) in the IOMMU), should such cached copies exist.

In some embodiments, the IOMMU uses information from a reverse map table (RMT) for determining encryption keys from among encryption keys associated with owning entities for memory access requests from IO devices. In these embodiments, reverse map table entries include identifiers for encryption keys with which data in corresponding pages of memory are encrypted. For example, in some embodiments, the identifiers for the encryption keys are stored in encryption key identifier bits in the reverse map table entries. For determining encryption keys for memory access requests in these embodiments, the IOMMU acquires the identifiers from the page table entries during reverse map table lookups/checks or by acquiring the identifiers from cached copies of information from reverse map table entries that were acquired during prior reverse map table checks (e.g., in a translation lookaside buffer in the IOMMU). For example, when performing checks for memory accesses (e.g., correctness checks for information acquired from page table entries, etc.) using the reverse map table, the IOMMU can read the identifier from the specified bits in the reverse map table entry or a cached copy thereof.

By handling accesses of encrypted pages of memory for IO devices in an electronic device in which software entities can be associated with different encryption keys for two or more regions of memory, the IOMMU avoids the need for interacting with the hypervisor and/or other entities for performing the memory accesses. In other words, in contrast to existing electronic devices, because the IOMMU is able to determine which encryption keys are to be used for memory accesses for IO devices, IO device memory accesses can be performed without involvement by the hypervisor and/or the other entities. This can help to reduce the load on a processor, a communication fabric, and the memory in the electronic device in comparison to the existing electronic devices. It can also help to make IO device memory accesses faster. Reducing load and increasing the speed of IO device memory accesses improves the overall operation of the electronic device, which increases user satisfaction with the electronic device. In addition, because, in some embodiments, the information for determining the encryption keys is stored in the page table, the IOMMU can use page table walking and caching mechanisms for acquiring the information in these embodiments (i.e., without the overhead of adding a new encryption key acquisition flow). Alternatively, because, in some embodiments, the information for determining the encryption keys is stored in the reverse map table, the IOMMU can use reverse map table checking and caching mechanisms for acquiring the information in these embodiments.

### Electronic Device

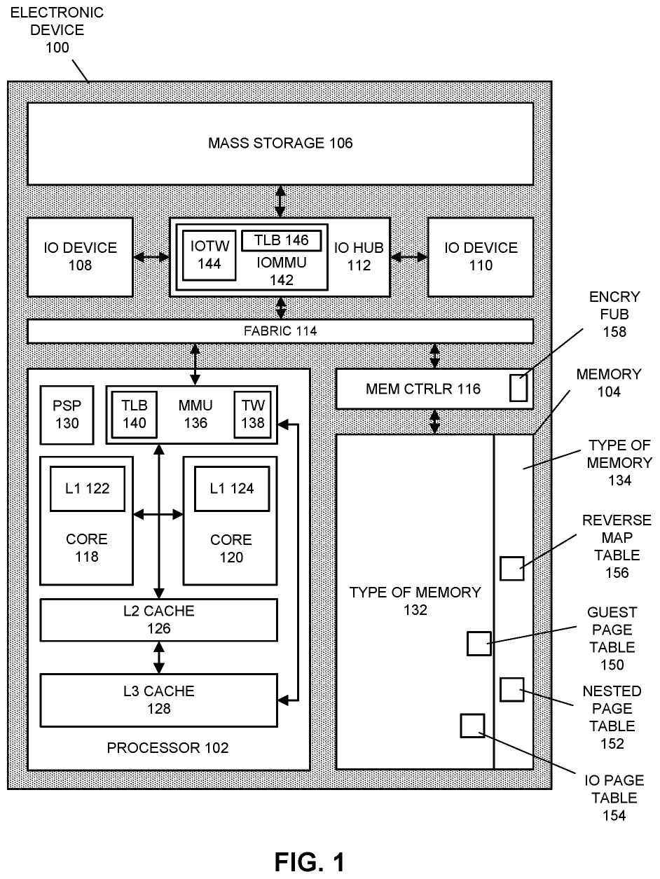

FIG. 1 presents a block diagram illustrating an electronic device 100 in accordance with some embodiments. As can be seen in FIG. 1, electronic device 100 includes processor 102, memory 104, mass storage 106, input-output (IO) devices 108-110, input-output (IO) hub 112, fabric 114, and memory controller (MEM CTRLR) 116. Processor 102, memory 104, mass storage 106, IO devices 108-110, IO hub 112, fabric 114, and memory controller 116 are all implemented in “hardware,” i.e., using corresponding integrated circuitry, discrete circuitry, and/or devices. For example, in some embodiments, processor 102, memory 104, mass storage 106, IO devices 108-110, IO hub 112, fabric 114, and memory controller 116 are implemented in integrated circuitry on one or more semiconductor chips, are implemented in a combination of integrated circuitry on one or more semiconductor chips in combination with discrete circuitry and/or devices, or are implemented in discrete circuitry and/or devices. In FIG. 1, electronic device 100 is partially shaded to enable the various figure elements to be more easily distinguished.

Processor 102 is a functional block that performs computational, memory access, control, and/or other operations in electronic device 100. Processor 102 includes cores 118-120, each of which includes one or more central processing unit (CPU) cores, graphics processing unit (GPU) cores, embedded processors, application specific integrated circuits (ASICs), and/or other functional blocks.

Processor 102 also includes cache memories, or “caches,” which are functional blocks that are used for storing copies of data that can be used by cores 118-120 for performing various operations. As can be seen in FIG. 1, the caches in processor 102 include level-one caches 122-124 (L1 122 and L1 124) in cores 118-120, respectively. Each of L1 caches 122-124 includes memory circuitry for storing data and control circuitry for handling accesses of data stored in the memory circuitry. Processor 102 also includes shared level-two (L2) cache 126 and level three (L3) cache 128 that each include memory circuitry for storing data and control circuitry for handling accesses of data stored in the memory circuitry.

Processor 102 further includes platform security processor (PSP) 130, which is a functional block that is used for performing security-related operations in electronic device 100. For example, in some embodiments, PSP 130 includes a CPU core, an ASIC, and/or a microcontroller. PSP 130 includes circuitry that is designed to be secure against specified malicious or erroneous behaviors of other functional blocks and devices in processor 102 and/or software entities executed by processor 102. PSP 130 can therefore be used for securing the operations of other functional blocks, devices, and/or software entities that are susceptible to such behavior. For example, PSP 130 can perform operations for registration and/or authentication of hardware and/or software entities, access permission verification, etc. In some embodiments, PSP 130 performs operations associated with encrypting data in pages of memory (or other portions of memory) in memory 104 assigned to software entities (e.g., a hypervisor, a guest operating system, etc.). For example, PSP 130 may generate, assign, and/or verify encryption keys or memory accesses for the software entities.

Memory 104 is a functional block that is used for storing data for other functional blocks in electronic device 100. For example, in some embodiments, memory 104 is a “main” memory in electronic device 100. Memory 104 includes memory circuitry for storing data and control circuitry for handling accesses of data stored in the memory circuitry.

In some embodiments, memory 104 includes two or more different types of memory that are arranged so that different portions of a set of addressable locations in memory 104 are in each of the types of memory. For example, in some embodiments, a fraction of the addressable locations (e.g., half) are in a first type of memory, and thus are implemented using a first type of memory circuitry, and the remaining addressable locations are in a second type of memory, and thus are implemented using a second type of memory circuitry. The use of two types of memory is illustrated in FIG. 1 via type of memory 132 and type of memory 134. Type of memory 132 can be implemented in memory circuitry such as fifth generation double data rate synchronous dynamic random access memory (DDR5 DRAM) and type of memory 134 can be implemented in memory circuitry such as 3D crosspoint (3D XPoint) memory.

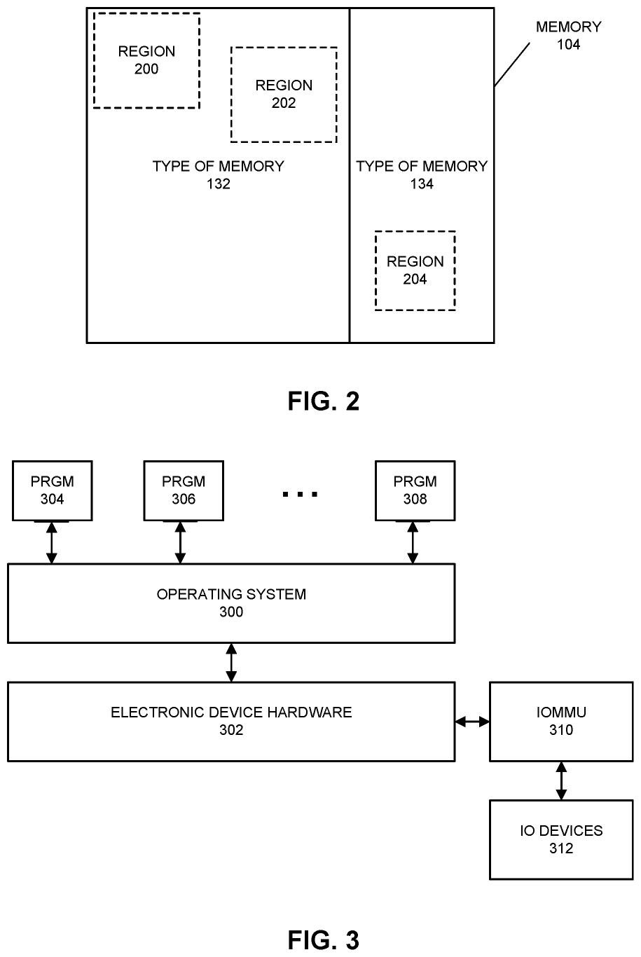

In some embodiments, memory 104 is partitioned into or includes a number of regions. Each of the regions includes a portion of memory circuitry in memory 104. FIG. 2 presents a block diagram illustrating regions in a memory in accordance with some embodiments. As can be seen in FIG. 2, type of memory 132 includes regions 200 and 202, each of regions 200-202 including a set or group of addressable locations of type of memory 132. For example, regions 200 and 202 can each include the addressable locations in M MiB from among N GiB of memory circuitry in type of memory 132. Type of memory 134 includes region 204, which includes a set or group of addressable locations in type of memory 134. Note, however, that although a particular arrangement of regions is shown in FIG. 2, in some embodiments, other arrangements of regions are used. For example, in some embodiments, each of types of memory 132-134 include only a single region—and the single region may include all of the addressable locations in the respective type of memory. As another example, in some embodiments, only a single type of memory is present and two or more regions include different groups of addressable locations in the single type of memory. Generally, the described embodiments are operable with any practical number and/or arrangement of regions in memory 104.

In some embodiments, entities in electronic device can be assigned pages of memory (or other portions of memory) in memory 104. For example, software entities such as a hypervisor or a guest operating system can be assigned respective pages of memory. Assigned pages of memory are reserved for storing data for (i.e., associated with, to be used by, to be available to, etc.) the entity to which the pages of memory are assigned. Continuing the software entity example, a hypervisor may be assigned a number of pages of memory that are reserved for storing data for the hypervisor, such as data generated by the hypervisor itself and/or stored in the pages of memory by other entities (e.g., functional blocks, IO devices, other software entities, etc.) to be made available to the hypervisor. In some embodiments, entities can be assigned pages in different regions of memory (e.g., in regions 200, 202, and/or 204), so that a given entity has pages of memory assigned in some or all of the regions of memory. Continuing the software entity example, a given guest operating system can be assigned one or more pages of memory in each of two or more regions.

Mass storage 106 is a functional block and/or device that stores data for use by other functional blocks and devices in electronic device 100. For example, mass storage 106 can be or include a semiconductor memory, a disk drive, an optical drive, etc. Mass storage 106 includes circuitry and/or devices that retain stored data despite electrical power for mass storage 106 being shut off and thus serves as non-volatile long term storage for data. At runtime (i.e., as electronic device 100 operates), copies of data are acquired from mass storage 106 and stored in memory 104 (and possibly one or more caches) for subsequent accesses by functional blocks in electronic device 100. For example, data may be acquired/read from mass storage 106 and stored in pages of memory in memory 104 (and data may be acquired from mass storage 106 in pages). In addition, data may be generated by functional blocks, IO devices, application programs, software entities, etc. in electronic device 100 and stored in pages of memory in memory 104 that may eventually be written out to mass storage 106.

Returning to processor 102, memory management unit (MMU) 136 is a functional block that handles memory access requests and requests for information from page tables. When data is to be accessed by a functional block in processor 102, the functional block sends a memory access request to MMU 136. For example, a software entity (e.g., a guest operating system, a hypervisor, etc.) being executed by core 118 may cause a load/store unit in processing circuitry in core 118 to send a memory access request (e.g., for a load or store of data, etc.) to MMU 136. MMU 136 then sends a corresponding memory access request to one or more of L2 cache 126, L3 cache 128, and memory controller 116 for satisfaction or resolution of the memory access request. For example, if data is to be loaded, MMU 136 may acquire the data from L2 cache 126, L3 cache 128, or memory controller 116 and forward the data to the requesting functional block. This may mean loading the data from mass storage 106 to memory 104, should the data not already be present in memory 104.

MMU 136 includes table walker (TW) 138, which is a functional block that performs operations related to acquiring address translation information and other information from page tables via page table walks. In some embodiments, upon receiving a memory access request from a software entity with a virtual address, table walker 138 performs page table walk operations for translating the virtual address into the physical address for the pages where data is located in memory 104. During page table walk operations, table walker 138 may also check page table entries and/or other records to ensure that the functional block and/or software entity that is requesting each memory access is permitted to perform such an access, i.e., is allowed to access the memory at the physical address, etc. and that the page table and other records used for the translation have not been impermissibly modified.

In some embodiments, table walker 138 uses two separate page tables for performing address translations. In some of these embodiments, the two page tables include a guest page table 150 and nested page table 152. Guest page table 150 and nested page table 152 are each a record that includes entries, or “page table entries,” for storing address translation information and other information for respective pages of memory in memory 104. For example, guest page table 150 can include page table entries with information for pages of memory presently in memory 104 that have been accessed by a corresponding guest operating system. In some embodiments, guest page table 150 includes guest virtual address to guest physical address translation information for pages of memory as well as respective other information (i.e., metadata, permissions information, etc.). As another example, nested page table 152 can include page table entries with information for pages of memory presently in memory 104 that have been accessed by a guest operating system and/or another software entity or functional block. Nested page table 152 (interchangeably called system page table, host page table, etc.) includes guest physical address to system physical address translation information for pages of memory as well as respective other information. In some embodiments, among the information stored in page table entries in nested page table 152 and/or guest page table 150 is encryption key identification information that is used for acquiring encryption keys for encryption operations for respective pages of memory as described herein.

Although only one guest page table 150 is shown in FIG. 1 as an example, in some embodiments, electronic device 100 includes a separate guest page table for each guest operating system (there may be multiple guest operating systems), with address translations used by/for that guest operating system and other information (e.g., encryption key identifiers for encryption keys used by that guest operating system, etc.). In addition, although guest page table 150 and nested page table 152 are shown in different types of memory, there is no requirement that guest page table 150 and nested page table 152 be stored in particular types of memory—guest page table 150 and nested page table 152 can be stored anywhere in memory 104. Also, although shown as a single entity in FIG. 1, in some embodiments, guest page table 150 and/or nested page table 152 are or include multiple separate page sub-tables that are used in combination for performing virtual address to physical address translations. For example, in some embodiments, one or both of guest page table 150 and nested page table 152 are hierarchical page tables that include two or more layers or levels of sub-tables (and may include multiple sub-tables at each layer), with each sub-table except a final sub-table indicating a next sub-table in the hierarchy to be searched for address translation information and the final table including the address translation information. In these embodiments, performing a table walk involves traversing each sub-table to get to the final sub-table where the address translation information is stored.

MMU 136 includes translation lookaside buffer (TLB) 140, which is a functional block that is used for storing, or “caching,” copies of information acquired from page table entries (e.g., from nested page table 152). TLB 140 includes memory circuitry that stores copies of page table entries or portions thereof acquired during page table walks by table walker 138 (or from other sources). In order to avoid performing page table walks, when possible, table walker 138 acquires address translation information and/or other page table entry information from TLB 140. If address translation information and/or other page table entry information is not present in TLB 140, however, table walker 138 performs a table walk in guest page table 150 and/or nested page table 152 to acquire the information.

Input-output (IO) devices 108-110 are functional blocks or devices that interact with processor 102 and/or other functional blocks and devices in electronic device 100. Processor 102 and/or the other functional blocks can therefore receive “input” data from or send “output” data to IO devices 108-110. IO devices 108-110 may also interact with functional blocks or devices external to electronic device 100. For example, input-output devices 108-110 can include network interface devices, disk controllers, devices coupled to corresponding wired or wireless buses or interfaces (e.g., a Peripheral Controller Interface Express (PCIe) bus, a Universal Serial Bus (USB), a WiFi network, etc.), graphics processing units, etc. The operations performed by each of IO devices 108-110 depends on the nature of each IO device. For example, if IO device 108 is a disk controller, IO device 108 may retrieve data from a disk (e.g., mass storage 106) and write data into memory 104 or vice versa. As another example, if IO device 110 is a network interface device, IO device 110 may store data received via a network (not shown) in memory 104, acquire data from memory 104 to be transmitted to a receiving device over the network, provide data to or acquire data from processor 102, etc.

IO hub 112 is a functional block or device that performs operations for interfacing between IO devices 108-110 and other functional blocks in electronic device 100. For example, in some embodiments, IO hub 112 performs operations associated with routing communications and other data between IO devices 108-110 and functional blocks such as processor 102, memory 104, etc. The communications that are routed by IO hub 112 and the operations that are performed for routing the communications depend on the nature of IO devices 108-110, but can include memory accesses, data communications, control and configuration communications, etc.

IO hub 112 includes input-output memory management unit (IOMMU) 142, which is a functional block that performs operations for handling memory accesses by IO devices 108-110. When data in memory 104 is to be accessed by a given IO device, the given IO device transmits a corresponding memory access request. IOMMU 142 intercepts the memory access request from the given IO device, processes the request internally to determine whether the memory access request can proceed, and then (assuming that the memory access request can proceed) sends a corresponding request to memory controller 116 for accessing the data.

Among the operations performed by IOMMU 142 for processing memory access requests from IO devices 108-110 is performing address translations for memory accesses for IO devices 108-110 (i.e., for acquiring system physical addresses in memory associated with guest physical addresses or guest virtual addresses used by IO devices 108-110 in memory access requests). IOMMU 142 includes input-output table walker (IOTW) 144, which a functional block that performs operations relating to acquiring address translations from page tables (e.g., page table walks, etc.). The operations performed by input-output (IO) table walker 144 are similar to those performed by table walker 138, albeit for memory accesses from IO devices 108-110 (rather than processor 102). In some embodiments, along with performing translations, IO table walker 144 checks metadata to determine whether memory accesses from IO devices 108-110 are permitted in pages of memory. In these embodiments, IO table walker 144 can block or otherwise handle memory accesses to avoid improper memory accesses. In some embodiments, IO table walker 144 also determines identifiers for encryption keys to be used for encryption operations for data in pages of memory accessed by IO devices 108-110 as described herein.

In some embodiments, IOMMU 142 uses an IOMMU-specific page table, IO page table 154, for performing address translations—or for performing a final translation operation in a sequence of address translation operations. IO page table 154 is a record that includes page table entries for storing address translation information and other information for respective pages of memory in memory 104. For example, IO page table 154 can include page table entries with information for pages of memory presently in memory 104 that have been accessed by an IO device. IO page table 154 includes guest physical address to system physical address translation information for pages of memory as well as respective other information (i.e., metadata, permissions information, etc.). In some embodiments, among the information stored in page table entries in IO page table 154 is encryption key identification information that is used for identifying encryption keys for encryption operations for data in pages of memory as described herein. In some embodiments, IO page table 154 is derived from or includes similar information to nested page table 152. Similarly to guest page table 150 and nested page table 152, although shown as a single entity in FIG. 1, IO page table 154 may include a hierarchy of separate sub-tables.

In some embodiments, as briefly described above, the IOMMU uses IO page table 154 for performing a final translation operation in a sequence of address translation operations. For example, in some embodiments, in contrast to embodiments in which the IO devices use guest physical addresses in memory accesses, IO devices can use guest virtual addresses (i.e., the addresses used by guest operating systems) in memory accesses. For such an IO device memory access, the IOMMU first translates the guest virtual address to a guest physical address using the guest page table 150 for the guest operating system. The IOMMU then uses IO page table 154 for translating the guest physical address to a system physical address to be used for the memory access. In some of these embodiments, guest operating systems can encrypt data in assigned pages of memory. Guest page tables 150 may therefore include encryption key identification information that is used for identifying encryption keys for encryption operations for data in pages of memory as described herein. When a guest page table 150 includes encryption key identification information, this encryption key identification information trumps/overrides encryption key identification information in the nested page table 152. In other words, when both the hypervisor and a guest operating system have added encryption key identification information to a page table entry in the respective page table (i.e., nested page table 152 for the hypervisor and a guest page table 150 for the guest operating system), the encryption key identification information provided by the guest operating system takes precedence—and will be used by the IOMMU (and other entities) for performing encryption-related operations.

IOMMU 142 also includes translation lookaside buffer (TLB) 146, which is a functional block that is used for storing copies of information acquired from page table entries in IO page table 154 (or elsewhere). TLB 146 includes memory circuitry that stores copies of page table entries or portions thereof acquired during page table walks by table walker IO table walker 144 (or from other sources). In order to avoid performing page table walks, when possible, IO table walker 144 acquires address translation information and/or other page table entry information from TLB 146. If address translation information and/or other page table entry information is not present in TLB 146, however, IO table walker 144 performs a table walk to acquire the information.

In some embodiments, electronic device 100 includes reverse map table (RMT) 156 in memory 104. Reverse map table 156 is a record that is used (e.g., by MMU 136, IOMMU 142, etc.) to detect when changes are made to nested page table 152 and otherwise protect pages of memory from impermissible accesses by guest operating systems, a hypervisor, and/or IO devices. Reverse map table 156 includes a number of entries, one entry for each page of memory in memory 104 that may be allocated for the use of one or more virtual machines. For example, if a memory 104 includes 32 GiB of memory that may be allocated in 4 KiB pages to virtual machines, reverse map table includes 8,388,608 entries. The entries in reverse map table 156 can store information such as identifiers of guest physical addresses that are associated with system physical addresses, the permissions levels for accessing virtual machines, identifiers for owners of pages of memory, and/or other information associated with corresponding pages. An example of a reverse map table is shown in FIG. 6 and described in more detail below. In some embodiments, when processing IO device memory access requests, IOMMU 142 (or IO table walker 144) checks a corresponding entry in reverse map table 156 to ensure that information in IO page table 154 is safe to use (i.e., has not been unexpectedly changed by the hypervisor) and that given memory accesses can be performed on the respective page of memory. In some embodiments, among the information stored in the reverse map table entries are identifiers for encryption keys that are used for encrypting data stored in corresponding pages of memory. In these embodiments, IOMMU 142 (or IO table walker 144) uses reverse map table entries to determine identifiers for encryption keys to be used for encryption operations for data in pages of memory accessed by IO devices 108-110 as described herein.

Fabric 114 is a functional block and/or device that performs operations for communicating information (e.g., commands, data, control signals, and/or other information) between functional blocks and devices in electronic device 100. For example, in some embodiments, fabric 114 is a system bus used by functional blocks for accessing data in memory 104 and/or communicating with one another. Communications on fabric 114 are organized and controlled (i.e., formatted, arranged, timed, etc.) in accordance with one or more communication standards or protocols. For example, in some embodiments, fabric 114 uses the Infinity Fabric standard from Advanced Micro Devices Inc. of Santa Clara, Calif. Fabric 114 includes some or all of communication paths (e.g., busses, wires, guides, etc.), controllers, switches, routers, etc. that are used for communicating the information. In some embodiments, in addition to fabric 114, communication paths are coupled between the functional blocks in electronic device 100 as shown by arrow-headed lines between the functional blocks. Communication paths include one or more routes, busses, wires, guides, and/or other connections possibly along with controllers, fabric elements (e.g., switches, routers, etc.), etc. The communication paths are used for carrying commands, data, control signals, and/or other information between functional blocks.

Memory controller 116 is a functional block that performs operations for handling communications between other functional blocks in electronic device 100 (e.g., processor 102 and IO hub 112) and memory 104. For example, in some embodiments, memory controller 116 performs operations for receiving and processing memory access requests from the other functional blocks in electronic device 100 (e.g., enforcing timing and/or ordering requirements, avoiding conflicts, etc.). In addition, in some embodiments, memory controller 116 and/or an encryption functional block (ENCRY FUB) 158 in memory controller 116 perform encryption operations for encrypting data to be stored in memory 104 and decrypting data to be read/loaded from memory 104. For example, in some embodiments, memory controller 116 receives memory access requests from IOMMU 142 via fabric 114 along with specifiers for encryption keys included in or associated with the memory access requests. Encryption functional block 158 uses the specifiers to acquire encryption keys for encryption operations for the corresponding memory accesses (e.g., encryption, decryption, data verification/checking, etc.). In some embodiments, memory controller 116 and/or encryption functional block 158 include or have access to a key record or store in which encryption keys are associated with identifiers. In these embodiments memory controller 116 and/or encryption functional block 158 use specifiers for encryption keys to acquire encryption keys from the key record/store (e.g., via a lookup operation, etc.).

Although electronic device 100 is shown in FIG. 1 with a particular number and arrangement of functional blocks and devices, in some embodiments, electronic device 100 includes different numbers and/or arrangements of functional blocks and devices. For example, in some embodiments, processor 102 includes a different number of cores. As another example, in some embodiments, a different number and/or arrangement of caches is present in processor 102. As yet another example, in some embodiments, fabric 114 and/or the other communications paths are arranged differently. As yet another example, although shown as being included in electronic device 100, in some embodiments, one or both of IO devices 108-110 are external IO devices such as IO devices coupled to electronic device 100 via a network, a wired or wireless connection, etc. As yet another example, in some embodiments encryption functional block 158 is located separately from memory controller 116, such as in memory 104, processor 102, and/or platform security processor 130. Generally, in the described embodiments, electronic device 100 includes sufficient numbers and/or arrangements of functional blocks to perform the operations herein described.

Electronic device 100 and processor 102 as shown in FIG. 1 are simplified for illustrative purposes. In some embodiments, however, electronic device 100 and/or processor 102 include additional or different elements and mechanisms for performing the operations herein described and other operations. For example, electronic device 100 and/or processor 102 may include power functional blocks or devices, human interface functional blocks or devices, etc.

In some embodiments, functional blocks shown separately in FIG. 1 are implemented together. For example, in some embodiments, some or all of IO hub 112 and IO devices 108-110 are incorporated in/with processor 102, such as being fabricated on the same integrated circuit chip. In other words, for such embodiments, IO hub 112 and IO devices 108-110 may be integrated with processor 102 (e.g., as a “system on a chip” or in another form). Alternatively, in some embodiments, functional blocks that are shown as part of other functional blocks may be separate. For example, in some embodiments, PSP 130 is implemented separately from processor 102.

Electronic device 100 can be, or can be included in, any electronic device that performs computational operations. For example, electronic device 100 can be, or can be included in, desktop computers, laptop computers, wearable electronic devices, tablet computers, smart phones, servers, artificial intelligence apparatuses, virtual or augmented reality equipment, network appliances, toys, audio-visual equipment, home appliances, controllers, vehicles, etc., and/or combinations thereof.

### Operating System

In some embodiments, a processor in an electronic device executes a number of software entities that cause the processor to perform various operations. In some embodiments, the software entities include an operating system. FIG. 3 presents a block diagram illustrating an operating system and electronic device hardware (i.e., functional blocks and devices) in an electronic device in accordance with some embodiments. Note that FIG. 3 is simplified and generally shows the relationship of an operating system with electronic device hardware. In some embodiments, some or all of the elements shown in FIG. 3 are not present and/or are arranged differently.

As can be seen in FIG. 3, operating system 300 interfaces between electronic device hardware 302 and a set of programs (PRGM) 304-308. For example, operating system 300 may be Windows® from Microsoft of Redmond, Wash., macOS® from Apple, Inc. of Cupertino, Calif., etc. and programs 304-308 may each be a productivity application, a scientific computing application, a web browser, etc. IOMMU 310 interfaces between IO devices 312 and electronic device hardware 302. In some embodiments, the functional blocks and devices in FIG. 3, i.e., electronic device hardware 302, IOMMU 310, and IO devices 312, are similar to hardware in electronic device 100 (e.g., processor 102, memory 104, etc.), IOMMU 142, and IO devices 108-110, respectively, as shown in FIG. 1.

### Virtual Machines and Hypervisor

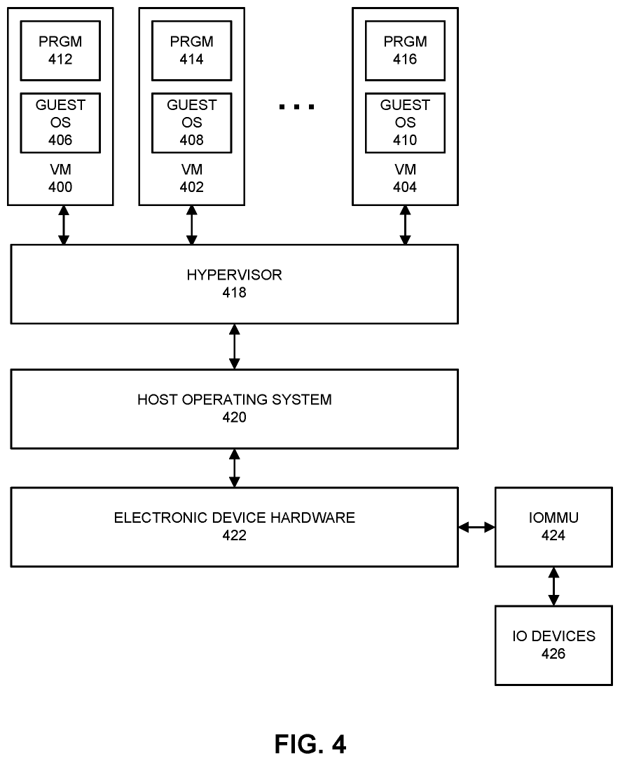

In some embodiments, a processor in an electronic device executes a hypervisor that performs various operations for managing virtual machines, etc. FIG. 4 presents a block diagram illustrating a hypervisor and electronic device hardware (i.e., functional blocks and devices) in an electronic device in accordance with some embodiments. As can be seen in FIG. 4, there are three virtual machines (VM) 400-404, on each of which executes a respective guest operating system (GUEST OS) 406-410 and one or more programs (PRGM) 412-416. Hypervisor 418 interfaces between a host operating system 420 and virtual machines 400-404. Host operating system 420 interfaces between electronic device hardware 422 and hypervisor 418. IOMMU 424 interfaces between IO devices 426 and electronic device hardware 422. In some embodiments, the functional blocks and devices in FIG. 4, i.e., electronic device hardware 422, IOMMU 424, and IO devices 426, are similar to hardware in electronic device 100 (e.g., processor 102, memory 104, etc.), IOMMU 142, and IO devices 108-110, respectively, as shown in FIG. 1.

FIG. 4 is simplified and generally shows the relationship of a hypervisor with electronic device hardware. In some embodiments, however, some or all of the elements shown in FIG. 4 are not present and/or are arranged differently. For example, in some embodiments, rather than communicating with electronic device hardware 422 via host operating system 420, hypervisor 418 communicates more directly with electronic device hardware 422. As another example, in some embodiments, the hypervisor itself is implemented in hardware (and also may not interface with electronic device hardware 422 via host operating system 420).

### Encryption of Data

In the described embodiments, data in a memory in an electronic device (e.g., memory 104) can be encrypted in order to protect the data from accesses by undesired entities. The data is encrypted using an encryption standard such as the Advanced Encryption Standard (e.g., AES-256 XTS, AES-128, etc.) or another encryption standard. Generally, in accordance with the encryption standard, a number of operations (e.g., bitwise, combinatorial, and/or mathematical) are performed using and/or based on the encryption key in order to convert unencrypted data to an encrypted form. For example, an encryption functional block can perform the operations using and/or based on the encryption key to convert data to the encrypted form/encrypt the data before storing the data in memory. The operations are then performed in reverse—or other operations are performed—using and/or based on the encryption key in order to decrypt encrypted data.

In the described embodiments, software entities (e.g., a hypervisor and/or guest operating systems) can be assigned pages of memory in which data is encrypted, i.e., can be assigned encrypted pages of memory. Generally, the data in each encrypted page of memory assigned to a given software entity is encrypted using an encryption key associated with the given software entity. For example, a page of memory assigned to a particular guest operating system can be encrypted using an encryption key associated with that particular guest operating system. In some embodiments, encryption keys associated with software entities are unique—and thus each encryption key is only used for encrypting data for a respective software entity.

In some embodiments, software entities can be assigned encrypted pages of memory in each of two or more regions of memory (e.g., some or all of regions 200-204). The data in each encrypted page of memory can be encrypted using an encryption key associated with the software entity and the region of memory. In other words, a given software entity can have a different encryption key for each region of memory, with each encryption key being used for encrypting data in pages of memory assigned to the given software entity in the respective region. For example, assuming that there are A regions in the memory and there are B software entities executing on the electronic device, there can be A*B encryption keys in use in the electronic device (where A=3, 5, or another number and B=2, 7, or another number).

In some embodiments, an electronic device supports a fixed number, or “pool,” of encryption keys. For example, there may be 256 eight-bit encryption keys or 1024 ten-bit encryption keys available in the pool of encryption keys. In these embodiments, encryption keys from the pool of encryption keys may be associated with (i.e., assigned or allocated to) software entities as needed. In some of these embodiments, the pool of encryption keys includes significantly more available encryption keys than the number of software entities that are expected to execute contemporaneously on the electronic device, so that there is normally no shortage of encryption keys.

Although embodiments are described in which data in pages of memory is encrypted, in some embodiments, at least some pages of memory assigned to a software entity are unencrypted—and thus the data therein is unencrypted. For example, a hypervisor or guest operating system may be assigned pages (e.g., read only pages, etc.) that are unencrypted. In some embodiments, a “key” identifier such as those described herein can be associated with such pages of memory, although the key identifier merely indicates to the memory controller and encryption functional block (or other entities) that the pages of memory are unencrypted. In these embodiments, continuing the A region, B software entity example, there may be more than A*B encryption keys in use in the electronic device. For example, if each software entity has both an encryption key and an unencrypted encryption key for each region of memory, there may be 2*A*B encryption keys in use in the electronic device. Note that, in some embodiments other protections can be used for unencrypted pages of memory, such as marking such pages as read-only, preventing undesired entities from accessing the page at all via permissions or other controlling metadata, etc.

### Process for Accessing Data in Encrypted Pages in a Memory

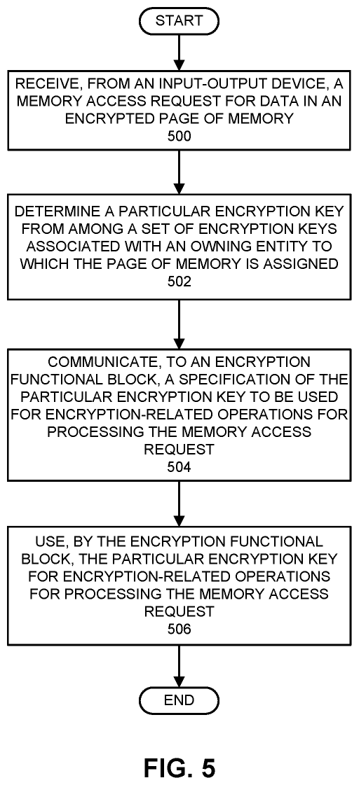

In the described embodiments, an IOMMU (e.g., IOMMU 142) performs operations for handling memory accesses by IO devices (e.g., IO devices 108-110) in encrypted pages in regions in a memory (e.g., regions 200-204). Generally, for handling IO device memory accesses, the IOMMU identifies encryption keys to be used for accessing data in encrypted pages of memory and then communicates specifications of the encryption keys to be used by an encryption functional block for encryption-related operations for the encrypted pages of memory (e.g., for encrypting and/or decrypting the data). FIG. 5 presents a flowchart illustrating a process for handling memory accesses for IO devices in encrypted pages of memory in regions in a memory in accordance with some embodiments. FIG. 5 is presented as a general example of operations performed in some embodiments. In other embodiments, however, different operations are performed and/or operations are performed in a different order.

The process shown in FIG. 5 starts when the IOMMU receives, from an IO device, a memory access request for data in an encrypted page of memory (step 500). For this operation, the IOMMU receives, from the IO device, a memory access request directed to specified data in the encrypted page of memory. The memory access request includes information for identifying a type of the memory access (i.e., read, write, move, delete, etc.), as well as address information for the specified data. For example, in some embodiments, the address information is or includes a guest physical address or a guest virtual address.

For the example in FIG. 5, it is assumed that the memory access is to access data in an encrypted page of memory that is located in a region of memory in a memory that includes two or more regions of memory. In addition, it is assumed that the page of memory is assigned to an owning entity—a guest operating system. The guest operating system is associated with (i.e., assigned, allocated, etc.) an encryption key for encryption-related operations (i.e., encryption, decryption, etc.) for encrypted pages of memory assigned to the guest operating system in each of the two or more regions of memory. Using regions 202 and 204 as an example, the guest operating system is therefore associated with a first encryption key for encryption operations for data in encrypted pages of memory in region 202 and a second encryption key for encryption operations for data in encrypted pages of memory in region 204.

The IOMMU next determines a particular encryption key from among a set of encryption keys associated with the owning entity to which the page of memory is assigned (step 502). For this operation, the IOMMU, using information from the memory access request and/or based on the memory access request, determines the particular encryption key to be used for encryption operations for the corresponding memory access. Generally, this operation involves the IOMMU looking up, requesting, or otherwise acquiring an identifier for the particular encryption key. For example, in some embodiments, each encryption key is identified using a ten-bit bit sequence (e.g., 0000010110 or another value) and thus the IOMMU acquires the appropriate bit sequence for the particular encryption key. The operations performed for determining the encryption key depend on how and where the identifier for the encryption key is stored. Examples of two embodiments, a first embodiment in which the encryption key identifier is stored in the page table entry and a second embodiment in which the encryption key identifier is stored in a reverse map table entry, are described below for FIGS. 6-11.

For the operation in step 502, the IOMMU determines the particular encryption key “from among a set of encryption keys associated with the owning entity” to which the page of memory is assigned (and, more generally, from among all encryption keys available and/or in use in the electronic device). The IOMMU therefore figures out, from among multiple encryption keys associated with the owning entity (a guest operating system), based on the region in which the page of memory is located, which encryption key is to be used for encryption-related operations for data in the page of memory. Continuing the region 202 and 204 example from above, assuming that the memory access request is directed to an encrypted page of memory in region 202, the IOMMU determines the particular encryption key from among a set of encryption keys associated with the owning entity/guest operating system that includes the first and second encryption keys—i.e., the first encryption key.

The IOMMU then communicates, to an encryption functional block, along with the memory access request, a specification of the particular encryption key to be used for encryption-related operations for processing the memory access request (step 504). For example, in some embodiments, the IOMMU includes the specification for the encryption key within a memory access request that is forwarded to a memory controller (e.g., memory controller 116). In some of these embodiments, the IOMMU includes the specification for the encryption key in a dedicated field or portion of the memory access request, i.e., in an encryption key identifier field or portion of the memory access request. In others of these embodiments, the IOMMU overloads the specification for the encryption key in a specified field or portion of the memory access request (i.e., by repurposing/overwriting otherwise unused bits with the specification). As another example, in some embodiments, the IOMMU communicates the specification for the encryption key to the memory controller separately, such as in a control message, on a sideband channel, via a shared mailbox memory location or register, etc.

The encryption functional block next uses the particular encryption key for encryption-related operations for processing the memory access request (step 506). For this operation, the encryption functional block retrieves, based on the specification, the particular encryption key from a key store and then uses the particular encryption key for performing at least one encryption-related operation for processing the memory access request. For example, in some embodiments, the key store is a table in which specifiers for encryption keys are associated with corresponding encryption keys. Continuing the ten-bit identifier example from above, the key store may associate each ten-bit specifier with an M-bit encryption key (where M=128, 256, or another number). In these embodiments, the encryption functional block receives, as the specification of the encryption key, a ten-bit identifier and uses the ten-bit identifier to retrieve the M-bit encryption key.

By performing the operations in FIG. 5, the IOMMU intervenes in an IO device memory access to enable the IO device—which may not itself support memory accesses of encrypted pages of memory—to access data in an encrypted page of memory in a memory that includes multiple regions in which respective different encryption keys are used. In other words, the IOMMU sorts out which encryption key is to be used for encryption-related operations for the IO device's memory access based on a combination of: (1) the owning entity to which the page of memory is assigned and (2) the region in memory in which the page of memory is located. This enables the IO device to continue to use existing memory access requests despite encrypted pages of memory being located in the multiple regions.

### Encryption Key Identifiers in Page Table Entries

As described above, in some embodiments, functional blocks and devices in an electronic device (e.g., processor 102, IOMMU 142, etc.) use one or more page tables (e.g., guest page table 150, nested page table 152, and/or IO page table 154) for performing address translations and for other operations. In some embodiments, identifiers for encryption keys used for encryption operations for data in encrypted pages of memory are stored/included in page table entries. For example, in some embodiments, the identifiers for the encryption keys are stored in page table entries in guest page tables (e.g., guest page table 150), an IO page table (e.g., IO page table 154), and/or a nested page table (e.g., nested page table 152). FIG. 6 presents a block diagram illustrating a page table 600 in accordance with some embodiments. Page table 600 as shown in FIG. 6 is presented as a generic example of a page table. In some embodiments, however, some or all of guest page table 150, IO page table 154, and nested page table 152 are internally arranged similarly to page table 600 (i.e., include similar information to page table 600).

As can be seen in FIG. 6, page table 600 includes a number of page table entries 602 (one of which is highlighted using a dashed line), each of which can store address information 604 and metadata 606. As pages of memory (i.e., blocks of data of a specified size, such as 4 KiB, 2 MiB, etc.) are retrieved from mass storage (e.g., mass storage 106) and stored in a memory (e.g., memory 104) or newly created in the memory, corresponding page table entries 602 are added to page table 600. Thus, if a page of memory is available in memory 104 and has been accessed by a software entity, functional block, or device associated with page table 600, page table 600 should include a corresponding page table entry 602. Recall that page table entries 602 are added to page table 600 to enable keeping track of mappings between the addresses used by accessing entities (e.g., software entities, functional blocks, and IO devices) and the addresses where data is located in memory.

In some embodiments, the address information 604 in each page table entry 602 includes information that can be used for determining a physical address (e.g., a guest physical address or system physical address) associated with a respective page of memory—and may simply include the physical address itself. In other words, address information 604 includes information that can be used to assist with identifying or identify a location in memory 104 for a page of memory for an accessing software entity, functional block, or device.

In some embodiments, identifiers for encryption keys are stored—more specifically, overloaded—in address information 604. The identifiers are therefore included within a sequence of bits in address information 604 in place of the corresponding address bits. For example, assuming that address information 604 stores a K-bit physical address (where K=52, 48, or another number), an encryption key identifier can be stored in a highest X bits of address information 604. Continuing the ten-bit encryption key identifier example from above, the encryption key identifier is stored in the Kth through K-9th bits of the address information 604. FIG. 7 presents a block diagram illustrating the overloading of an encryption key identifier in address information in a page table entry in accordance with some embodiments. As can be seen in FIG. 7, address information 604 includes a number of bits 700 (only a few of which are labeled for clarity) that are typically used for storing respective bits of a physical address 702 (which can be a guest physical address or system physical address, depending on the particular page table in which physical address 702 is located). In some embodiments, however, encryption key identifier 704 is overloaded into a highest 10 bits of physical address 702. In other words, the highest 10 bits of physical address 702, instead of being used for storing address information, are used for storing encryption key identifier 704. Note that this reduces the addressable scope of the physical address, but removes address bits that were otherwise not used, were known, and/or are determinable. In addition, although a particular arrangement of bits is shown in FIG. 7, in some embodiments, a different arrangement and/or number of bits is used.

Returning to FIG. 6, metadata 606 includes information associated with, characterizing, controlling, and/or otherwise relevant to the corresponding address information 604 and/or the respective page of memory. As address information for a page of memory is added to a page table entry 602 in page table 600, metadata is acquired, generated, etc. and added to that page table entry 602.

In some embodiments, identifiers for encryption keys are included in metadata 606. For example, in some embodiments, the identifiers are included in a dedicated field or portion of the metadata. FIG. 8 presents a block diagram illustrating an encryption key identifier in metadata in a page table entry in accordance with some embodiments. As can be seen in FIG. 8, metadata 606 includes validity 800, permissions 802, control 804, and encryption key information (ENCRY KEY INFO) 806. Validity 800 includes one or more values that relate to the validity of the page table entry 602, address information 604 in that page table entry 602, and/or the corresponding page of memory. Permissions 802 includes one or more values that relate to access permissions for the corresponding page of memory. Control 804 includes one or more values that relate to the use of the page table entry 602 and/or the corresponding page of memory. Encryption key information 806 includes an identifier for an encryption key to be used for encryption operations for the corresponding page of memory. For example, assuming that ten-bit encryption key identifiers are used, encryption key information 806 can include a ten-bit encryption key identifier.

When attempting to acquire address information or metadata for a memory access request, a table walker (e.g., table walker 138, IO table walker 144) or another entity in electronic device 100 performs a page table walk. During a page table walk, the table walker searches page table 600 to find a page table entry 602, should such an page table entry 602 exist, in which a corresponding address information 604 is held. Upon encountering such a page table entry 602, MMU 136, IOMMU 142, etc. acquire, from the page table entry 602, the address and metadata. For example, IOMMU 142 can acquire a system physical address associated with a guest physical address or a guest physical address associated with a guest virtual address. If the MMU 136, IOMMU 142, etc. is unable to find a corresponding page table entry 602, an error-handling operation is performed (e.g., a page fault is emitted and subsequently processed, etc.).

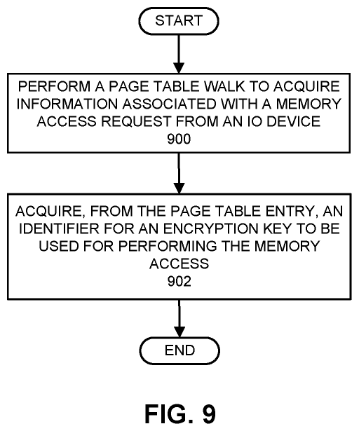

FIG. 9 presents a flowchart illustrating a process for determining an encryption key from among a set of encryption keys using information from a page table entry in accordance with some embodiments. FIG. 9 is presented as a general example of operations performed in some embodiments. In other embodiments, however, different operations are performed and/or operations are performed in a different order.

For the example in FIG. 9, it is assumed that an IO table walker (e.g., IO table walker 144) performs a table walk in an IO page table (e.g., IO page table 154) to acquire a system physical address associated with a guest physical address in a memory access request from an IO device—and thus the IO device uses a guest physical address in the memory access. In some embodiments, however, the IO device uses a guest virtual address in the memory access request. In these embodiments, although the IO table walker generally performs the operations of FIG. 9, the guest virtual address is first translated to a guest physical address using a respective guest page table (e.g., guest page table 150) and the guest physical address is subsequently translated to a system physical address using IO page table 154, which can mean performing two separate table walks to perform the translation. In some embodiments, guest operating systems themselves encrypt data in pages of memory—and thus can include identifiers for encryption keys to be used for performing memory accesses in the guest page table. When an identifier for an encryption key is found in a guest page table during the walk of the guest page table, that identifier trumps/overrides an identifier for an encryption key to be used for performing the memory access that is found in IO page table 154 during the walk of IO page table 154 (if any). In other words, when both a guest operating system and the hypervisor provide a respective identifier for an encryption key to be used for performing the memory access, the identifier for the encryption key provided by the guest operating system in the guest page table takes precedence—and is thus used for encryption-related operations for data in a corresponding page of memory. On the other hand, when a guest operating system does not provide an identifier for an encryption key to be used for performing the memory access but the hypervisor does, the encryption key identified in the IO page table is used for encryption related operations.

The process in FIG. 9 starts when the IO table walker performs a page table walk to acquire information associated with a memory access request from an IO device (step 900). For this operation, the IO table walker, and, more generally, the IOMMU, receives a memory access request to access data in a page of memory from the IO device. Based on the memory access request, IO table walker performs the page table walk in the IO page table to acquire the information associated with the memory access request. For example, in some embodiments, among the information acquired from the IO page table is a system physical address associated with a guest physical address in the memory access request as listed in a corresponding page table entry (e.g., in address information 604). As another example, in some embodiments, the information acquired from the IO page table includes permissions information, control information, etc. (e.g., metadata 606) from corresponding page table entry that is used by the IO table walker, the IOMMU, and/or other functional blocks to determine that the information from the page table entry can be used, the requested memory access is permissible for the requesting IO device, etc.

As part of acquiring the information during the page table walk, the IO table walker acquires, from the corresponding page table entry, an identifier for an encryption key to be used for performing the memory access (step 902). For this operation, the IO table walker acquires an identifier such as an N-bit identifier (e.g., an eight-bit identifier, etc.) that identifies the encryption key among a set of encryption keys that are used for performing encryption-related operations for an owning entity (e.g., a guest operating system, a hypervisor) to which a page of memory to be accessed is assigned. For example, in some embodiments, the IO table walker acquires the identifier from address information (e.g., from specified bits of a physical address) as described above for FIG. 7. As another example, in some embodiments, the IO table walker acquires the identifier from metadata (e.g., encryption key information 806) in the corresponding page table entry as described above for FIG. 8. In this way, the IO table walker “determines” the encryption key by acquiring the identifier for the encryption key as described above for step 502 in FIG. 5.

Note that, although a page table walk is described for FIG. 9, in some cases, the information that is described as being acquired from a page table entry can instead be acquired from a cache/translation lookaside buffer in the IOMMU (e.g., TLB 146). In these cases, the operations are similar to those described for FIG. 9, albeit using a cached copy of information from the page table entry instead of information from the page table entry itself.

### Encryption Key Identifiers in Reverse Map Table Entries

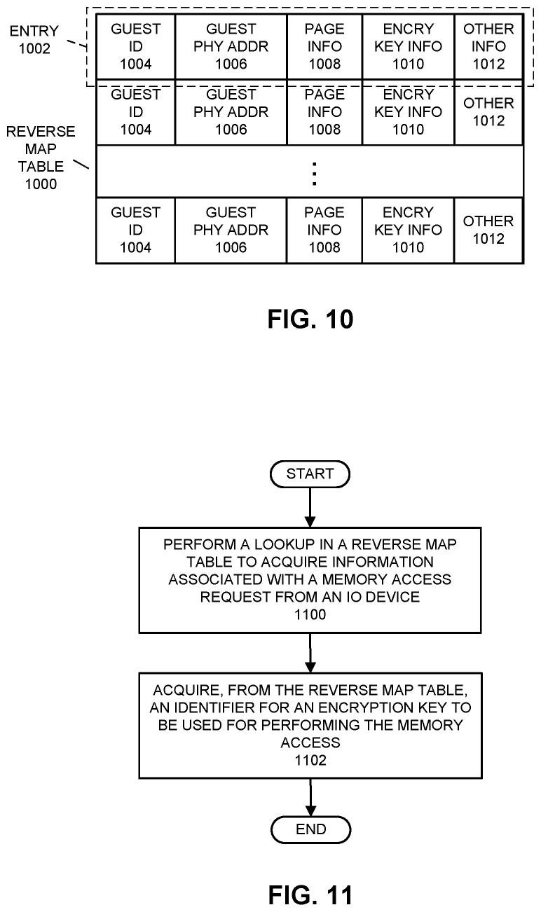

As described above, in some embodiments, functional blocks and devices in an electronic device (e.g., MMU 136, IOMMU 142, etc.) use a reverse map table for verifying the correctness of entries in page table(s) and for other operations. In some embodiments, the other operations include acquiring identifiers for encryption keys that are stored in entries in the reverse map table to be used for encryption-related operations for memory accesses in encrypted pages of memory. FIG. 10 presents a block diagram illustrating a reverse map table 1000 in accordance with some embodiments. In some embodiments, reverse map table 156 is internally arranged (i.e., includes similar information to) reverse map table 1000. Although reverse map table 1000 is shown in FIG. 10 as including particular information, in some embodiments, a different arrangement or type of information may be present. Generally, reverse map table 1000 includes sufficient information to perform the operations herein described.

In the following paragraphs, reverse map table 1000 is described in sufficient detail to understand the operations using a reverse map table in this description. Certain details of the reverse map table and operations for maintaining and using the reverse map table, however, are described briefly or left out for clarity and brevity. A more detailed description of a reverse map table and some examples of operations on and using the reverse map table can be found in U.S. Pat. No. 10,509,736, which issued on 17 Dec. 2019, and which is incorporated by reference herein.

As can be seen in FIG. 10, reverse map table 1000 includes a number of entries 1002 (an entry 1002 is highlighted using a dashed line in FIG. 10). Each entry 1002 includes information about a corresponding page in memory—and, in some embodiments, each allocatable page in memory will have a respective reverse map table entry. In some embodiments, the entries in reverse map table 1000 are indexed using system physical addresses associated with each page of memory, so that each entry 1002 is associated with a separate system physical address. For example, a first entry in reverse map table 1000 may be associated with a page of memory at a lowest system physical address (e.g., address A in an address space of the memory), a second entry in reverse map table 1000 may be associated with a page of memory at a second lowest system physical address (e.g., address A+4 KiB−1, for 4 KiB pages of memory), and so forth.

In some embodiments, each entry 1002 is used for storing a guest identifier (ID) 1004, a guest physical address (PHY ADDR) 1006, page information (INFO) 1008, encryption key information (ENCRY KEY INFO) 1010, and other information (INFO) 1012 for a respective page of memory. Guest identifier 1004 is an identifier associated with one or more entities (e.g., a guest operating system, hypervisor, a shared page of memory, etc.) to which the corresponding page of memory is assigned/allocated. Guest physical address 1006 is the guest physical address (or a portion thereof) previously used by the one or more entities to which the page of memory at system physical address for the entry 1002 is assigned. Page information 1008 includes information about the page of memory, such as a sub-page count for the page of memory (e.g., a number of 4 KiB pages within a 2 MiB page, etc.), a size of the page of memory (e.g., in bytes), an assigned indicator that indicates whether the entry 1002 is currently assigned to one or more guest operating systems, a lock indicator that indicates whether the entry 1002 is presently locked (e.g., for updating, etc.). Encryption key information 1010 includes an identifier for an encryption key to be used for encryption-related operations (e.g., encryption, decryption, etc.) for data in the page of memory at the system physical address with which the entry 1002 is associated. For example, in some embodiments, the identifier is an N-bit identifier (where N=8, 10, or another number).

Other information 1012 includes information for and/or about the page of memory, the guest operating system(s) to which the page is allocated, entry 1002 itself, and/or other information that is useful for controlling access to entry 1002 and/or the page of memory. For example, in some embodiments, other information 1012 includes some or all of: a validated indicator that indicates whether the entry 1002 has been validated, a permissions level block with sets of permissions for the corresponding page of memory, a shared pages indicator that indicates whether the corresponding page is shared by two or more guest operating systems, etc.

FIG. 11 presents a flowchart illustrating a process for determining an encryption key from among a set of encryption keys using information from a reverse map table entry in accordance with some embodiments. FIG. 11 is presented as a general example of operations performed in some embodiments. In other embodiments, however, different operations are performed and/or operations are performed in a different order.

The process in FIG. 11 starts when an IOMMU (e.g., IOMMU 142) or a functional block therein (e.g., IO table walker 144) performs a lookup in a reverse map table to acquire information associated with a memory access request from an IO device (step 1100). For this operation, the IOMMU receives a memory access request to access data in a page of memory from the IO device. Using a system physical address acquired during a page table walk or a TLB check for the memory access request, the IOMMU performs the lookup in the reverse map table to acquire the information associated with the memory access request. For example, in some embodiments, among the information acquired from the reverse map table is a recorded guest physical address that was previously associated with the system physical address. The IOMMU compares the recorded guest physical address to a guest physical address from the memory access request to ensure that the mapping in the page table (from which the system physical address was acquired) was not unexpectedly changed. As another example, in some embodiments, the information acquired from the reverse map table includes permissions information, page size information, etc. that is used by the IOMMU and/or other functional blocks to determine whether the requested memory access is to be allowed to proceed (e.g., whether a size of the page of memory is sufficiently large for the requested memory access, whether the IO device has permissions for the requested memory access, etc.).

As part of acquiring the information during the reverse map table lookup, the IOMMU acquires an identifier for an encryption key to be used for performing the memory access from the reverse map table (step 1102). For this operation, the IOMMU acquires an identifier such as an N-bit identifier (e.g., an eight-bit identifier, etc.) that identifies the encryption key among a set of encryption keys that are used for performing encryption-related operations for an owning entity (e.g., a guest operating system, a hypervisor) to which a page of memory to be accessed is assigned. For example, in some embodiments, the IOMMU acquires the identifier from encryption key information 1010 as described for FIG. 10. In this way, the IO table walker “determines” the encryption key by acquiring the identifier for the encryption key as described above for step 502 in FIG. 5.

Note that, although a reverse map table check is described for FIG. 11, in some cases, the information that is described as being acquired from the reverse map table can instead be acquired from a cache/translation lookaside buffer in the IOMMU (e.g., TLB 146). In these cases, the operations are similar to those described for FIG. 11, albeit using a cached copy of information from the reverse map table instead of information from the reverse map table itself.

In some embodiments, at least one electronic device (e.g., electronic device 100, etc.) uses code and/or data stored on a non-transitory computer-readable storage medium to perform some or all of the operations described herein. More specifically, the at least one electronic device reads code and/or data from the computer-readable storage medium and executes the code and/or uses the data when performing the described operations. A computer-readable storage medium can be any device, medium, or combination thereof that stores code and/or data for use by an electronic device. For example, the computer-readable storage medium can include, but is not limited to, volatile and/or non-volatile memory, including flash memory, random access memory (e.g., eDRAM, RAM, SRAM, DRAM, DDR4 SDRAM, etc.), non-volatile RAM (e.g., phase change memory, ferroelectric random access memory, spin-transfer torque random access memory, magnetoresistive random access memory, etc.), read-only memory (ROM), and/or magnetic or optical storage mediums (e.g., disk drives, magnetic tape, CDs, DVDs, etc.).

In some embodiments, one or more hardware modules perform the operations described herein. For example, the hardware modules can include, but are not limited to, one or more central processing units (CPUs)/CPU cores, graphics processing units (GPUs)/GPU cores, application-specific integrated circuit (ASIC) chips, field-programmable gate arrays (FPGAs), compressors or encoders, encryption functional blocks, compute units, embedded processors, accelerated processing units (APUs), controllers, requesters, completers, network communication links, and/or other functional blocks. When circuitry (e.g., integrated circuit elements, discrete circuit elements, etc.) in such hardware modules is activated, the circuitry performs some or all of the operations. In some embodiments, the hardware modules include general purpose circuitry such as execution pipelines, compute or processing units, etc. that, upon executing instructions (e.g., program code, firmware, etc.), performs the operations. In some embodiments, the hardware modules include purpose-specific or dedicated circuitry that performs the operations, possibly including circuitry that performs some or all of the operations “in hardware” and without executing instructions.

In some embodiments, a data structure representative of some or all of the functional blocks and circuit elements described herein (e.g., electronic device 100, or some portion thereof) is stored on a non-transitory computer-readable storage medium that includes a database or other data structure which can be read by an electronic device and used, directly or indirectly, to fabricate hardware including the functional blocks and circuit elements. For example, the data structure may be a behavioral-level description or register-transfer level (RTL) description of the hardware functionality in a high-level design language (HDL) such as Verilog or VHDL. The description may be read by a synthesis tool which may synthesize the description to produce a netlist including a list of transistors/circuit elements from a synthesis library that represent the functionality of the hardware including the above-described functional blocks and circuit elements. The netlist may then be placed and routed to produce a data set describing geometric shapes to be applied to masks. The masks may then be used in various semiconductor fabrication steps to produce a semiconductor circuit or circuits (e.g., integrated circuits) corresponding to the above-described functional blocks and circuit elements. Alternatively, the database on the computer accessible storage medium may be the netlist (with or without the synthesis library) or the data set, as desired, or Graphic Data System (GDS) II data.

In this description, variables or unspecified values (i.e., general descriptions of values without particular instances of the values) are represented by letters such as N, M, and X. As used herein, despite possibly using similar letters in different locations in this description, the variables and unspecified values in each case are not necessarily the same, i.e., there may be different variable amounts and values intended for some or all of the general variables and unspecified values. In other words, particular instances of N and any other letters used to represent variables and unspecified values in this description are not necessarily related to one another.

The expression “et cetera” or “etc.” as used herein is intended to present an and/or case, i.e., the equivalent of “at least one of” the elements in a list with which the etc. is associated. For example, in the statement “the electronic device performs a first operation, a second operation, etc.,” the electronic device performs at least one of the first operation, the second operation, and other operations. In addition, the elements in a list associated with an etc. are merely examples from among a set of examples—and at least some of the examples may not appear in some embodiments.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. An electronic device, comprising:
a memory; and
an input-output memory management unit (IOMMU) configured to:
receive, from an input-output (IO) device, a memory access request directed to a given page of memory stored in the memory;
determine a particular encryption key from among a plurality of encryption keys associated with an owning entity to which the given page of memory is assigned; and
communicate, to an encryption functional block, a specification of the particular encryption key to be used for encryption-related operations for processing the memory access request.

2. The electronic device of claim 1, further comprising:
the memory including at least two regions, the memory configured to:
store a plurality of pages of memory including the given page of memory, each of the pages of memory being stored in one of the regions of the memory and assigned to a respective owning entity from among a plurality of owning entities, wherein data in each page of memory is:
unencrypted, or
encrypted using an encryption key that is used for encrypting pages of memory in the respective region for an owning entity to which that page of memory is assigned.

3. The electronic device of claim 2, wherein each owning entity is associated with a plurality of encryption keys, each plurality of encryption keys including a different encryption key for each region of the memory.

4. The electronic device of claim 2, wherein:
the memory is further configured to:
store a page table including a page table entry with information about or associated with each page of memory of the plurality of pages of memory, the information in each page table entry including an identifier for an encryption key with which data in a corresponding page of memory is encrypted; and
the IOMMU is further configured to:
acquire, from a corresponding page table entry or a locally cached copy of the corresponding page table entry, the identifier for the particular encryption key to be used for determining the particular encryption key.

5. The electronic device of claim 4, wherein the identifier for the encryption key is stored in specified bits of address information in each page table entry, the specified bits being overloaded with the identifier.

6. The electronic device of claim 4, wherein the IOMMU acquires the identifier for the particular encryption key during an address translation operation for the memory access request.

7. The electronic device of claim 2, wherein:
the memory is further configured to:
store a reverse map table (RMT) that includes an RMT entry with information about or associated with each page of memory of the plurality of the pages of memory, the information including an identifier for an encryption key with which data in a corresponding page of memory is encrypted; and
the IOMMU is further configured to:
acquire, from a corresponding RMT entry, the identifier for the particular encryption key to be used for determining the particular encryption key.

8. The electronic device of claim 2, further comprising:
a processor that is configured to:
execute a hypervisor and one or more guest operating systems, wherein the plurality of owning entities include the hypervisor and the one or more guest operating systems.

9. The electronic device of claim 1, further comprising:
the encryption functional block configured to:
receive, from the IOMMU, the specification of the particular encryption key;
retrieve, based on the specification, the particular encryption key from a key store; and
use the particular encryption key for performing at least one encryption-related operation for processing the memory access request.

10. A method for performing memory accesses in an electronic device, the method comprising:
receiving, from an input-output (IO) device, a memory access request directed to a given page of memory;
determining a particular encryption key from among a plurality of encryption keys associated with an owning entity to which the given page of memory is assigned; and
communicating, to an encryption functional block, a specification of the particular encryption key to be used for encryption-related operations for processing the memory access request.

11. The method of claim 10, wherein the method further comprises:
storing, in a memory that includes two or more regions, a plurality of pages of memory including the given page of memory, each of the pages of memory being stored in one of the regions of the memory and assigned to a respective owning entity from among a plurality of owning entities, wherein data in each page of memory is:
unencrypted, or
encrypted using an encryption key that is used for encrypting pages of memory in the respective region for an owning entity to which that page of memory is assigned.

12. The method of claim 11, wherein each owning entity is associated with a plurality of encryption keys, each plurality of encryption keys including a different encryption key for each region of the memory.

13. The method of claim 11, wherein the method further comprises:
storing a page table including a page table entry with information about or associated with each page of memory of the plurality of pages of memory, the information in each page table entry including an identifier for an encryption key with which data in a corresponding page of memory is encrypted; and
acquiring, from a corresponding page table entry or a locally cached copy of the corresponding page table entry, the identifier for the particular encryption key to be used for determining the particular encryption key.

14. The method of claim 13, wherein the method further comprises:
storing the identifier for the encryption key in specified bits of address information in each page table entry, the specified bits being overloaded with the identifier.

15. The method of claim 13, wherein the method further comprises:
acquiring the identifier for the particular encryption key during an address translation operation for processing the memory access request.

16. The method of claim 11, wherein the method further comprises:
storing a reverse map table (RMT) that includes an RMT entry with information about or associated with each page of memory of the plurality of the pages of memory, the information including an identifier for an encryption key with which data in a corresponding page of memory is encrypted; and
acquiring, from a corresponding RMT entry, the identifier for the particular encryption key to be used for determining the particular encryption key.

17. The method of claim 10, wherein the method further comprises:
receiving, by the encryption functional block, the specification of the particular encryption key;
retrieving, based on the specification, the particular encryption key from a key store; and
using the particular encryption key for performing at least one encryption-related operation for processing the memory access request.

18. An input-output memory management unit (IOMMU) configured to:
receive, from an input-output (IO) device, a memory access request directed to a given page of memory;
determine a particular encryption key from among a plurality of encryption keys associated with an owning entity to which the given page of memory is assigned; and
communicate, to an encryption functional block, a specification of the particular encryption key to be used for encryption-related operations for processing the memory access request.

19. The IOMMU of claim 18, wherein:
a plurality of pages of memory including the given page of memory are stored in a memory that includes at least two regions, each of the pages of memory being stored in one of the regions of the memory and assigned to a respective owning entity from among a plurality of owning entities; and
data in each page of memory is:
unencrypted, or
encrypted using an encryption key that is used for encrypting pages of memory in the respective region for an owning entity to which that page of memory is assigned.

20. The IOMMU of claim 19, wherein:
a page table including a page table entry with information about or associated with each page of memory of the plurality of pages of memory is stored in the memory, the information in each page table entry including an identifier for an encryption key with which data in a corresponding page of memory is encrypted; and
the IOMMU is further configured to:
acquire, from a corresponding page table entry or a locally cached copy of the corresponding page table entry, the identifier for the particular encryption key to be used for determining the particular encryption key.

21. The IOMMU of claim 19, wherein:
a reverse map table (RMT) that includes an RMT entry with information about or associated with each page of memory of the plurality of the pages of memory is stored in the memory, the information including an identifier for an encryption key with which data in a corresponding page of memory is encrypted; and
the IOMMU is further configured to:
acquire, from a corresponding RMT entry, the identifier for the particular encryption key to be used for determining the particular encryption key.
